(19) United States
(12) Patent Application Publication
(10) Pub. No.: US 2008/0308497 A1
(43) Pub. Date: Dec. 18, 2008

(54) Filter Element

(76) Inventors: Malcolm David Walker, Midrand (ZA); Roger William Gemmell, Greenstone Hill (ZA); Hector Brian Salzwedel, Benoni (ZA)

Correspondence Address: FROMMER LAWRENCE & HAUG, 745 FIFTH AVENUE- 10TH FL., NEW YORK, NY, 10151, US

(21) Appl. No.: 12/095,407

(22) PCT Filed: Nov. 29, 2006
(86) PCT No.: PCT/IB06/54507

§ 371 Date: Jun. 17, 2008

(30) Foreign Application Priority Data
Dec. 1, 2005 (ZA) 2005-09747

(51) Int. Cl. B01D 39/16; B01D 39/18

(52) U.S. Cl. 210/654; 210/500.21; 210/487; 264/103

(57) ABSTRACT

A radial flow filter element (10) includes at least one wound body (14) comprising a radially extending filtration zone (20) with alternating co-wound liquid-permeable layers respectively of a predominantly cellulosic material and a predominantly synthetic plastics or polymeric material.

THIS INVENTION relates to a filter element. In particular, the invention relates to a radial flow filter element, to a method of filtering a liquid, and to a method of making a radial flow filter element.

According to one aspect of the invention, there is provided a radial flow filter element which includes at least one wound body comprising a radially extending filtration zone with alternating co-wound liquid-permeable layers respectively of a predominantly cellulosic material and a predominantly synthetic plastics or polymeric material.

By “radially extending” is meant a zone having a radial dimension or thickness, but not necessarily a zone starting at a centre of a cylindrical body.

The synthetic plastics or polymeric material may have a higher liquid permeability than the cellulosic material. By this is meant that a layer of particular thickness of the synthetic plastics or polymeric material would pass more of a particular liquid in a given time period, compared to a layer of the same thickness of the cellulosic material under application of equal differential pressures. Accordingly, the layers of synthetic plastics or polymeric material may have a higher liquid permeability than the layers of cellulosic material.

The layers of the cellulosic material and/or the synthetic plastics or polymeric material may include more than one ply of respectively cellulosic material or synthetic plastics or polymeric material.

In one embodiment of the invention, the layers of cellulosic material are formed from a length of cellulosic material of at least two plies, e.g. two plies, and the layers of synthetic plastics or polymeric material are formed from a length of synthetic plastics or polymeric material of single ply.

The cellulosic material and the synthetic plastics or polymeric material may be compatible with oil and liquid hydrocarbon fuels, rendering the filter element an oil or fuel filter element.

The cellulosic material may have a basis mass, for the combined plies, of between about 12 g/m² and about 36 g/m². The cellulosic material may instead have a basis mass, for the combined plies, of between about 16 g/m² and about 36 g/m². Instead, the cellulosic material may have a basis mass, for the combined plies, of between about 30 g/m² and about 36 g/m², e.g. about 33 g/m².

The synthetic plastics or polymeric material may be polyester. The polyester may have a basis mass of between about 10 g/m² and about 40 g/m². The polyester may instead have a basis mass of between about 15 g/m² and about 35 g/m². Instead, the polyester may have a basis mass of between about 20 g/m² and about 30 g/m², e.g. about 25 g/m².

The synthetic plastics or polymeric material may be polypropylene.

The filter element may include a hollow liquid-permeable core around which the layers of the wound body are wound. The liquid permeability of the hollow core may be provided by a plurality of apertures through a typically circular cylindrical wall of the hollow core. In other words, the hollow core may be perforated. The core may be of a cellulosic material, e.g. cardboard, and may have a wall thickness of between about 1 mm and about 3 mm, e.g. about 2 mm. Instead, the core may be of a synthetic plastics or polymeric material, and may be of cage-like structure.

The wound body may include a radially spaced inner or filler zone which extends radially inwardly from the filtration zone and which is thus concentric with the filtration zone. The inner or filler zone may extend radially between the core and the filtration zone.

The inner or filler zone may comprise liquid-permeable wound layers predominantly of a synthetic plastics or polymeric material. In one embodiment of the invention, the inner or filler zone comprises liquid-permeable wound layers of a synthetic plastics or polymeric material only, e.g. polyester, without any layers of a cellulosic material.

The wound body may include a radially extending outer zone which comprises liquid-permeable wound layers predominantly of a synthetic plastics or polymeric material. When present, the outer zone is thus concentric with the filtration zone. In one embodiment of the invention, the outer zone comprises liquid-permeable wound layers of a synthetic plastics or polymeric material only, e.g. polyester, without any layers of a cellulosic material.

The filtration zone and/or the outer zone, when present, should have a radial thickness of at least 2 mm.

At least some of the liquid-permeable layers of synthetic plastics or polymeric material of the outer zone may be heat-welded together along at least one heat weld seam, which may extend longitudinally relative to the wound body.

Ends of the wound body may be provided with liquid-impermeable end caps. The end caps may be in the form of coatings of a liquid-impermeable material, e.g. rubberised coatings.

According to another aspect of the invention, there is provided a method of filtering a liquid, the method including forcing the liquid through a body comprising alternating liquid-permeable layers predominantly of a cellulosic material and predominantly of a synthetic plastics or polymeric material, the layers forming contact areas between them and the flow of liquid being normal to the contact areas.

The alternating layers may be co-wound layers forming part of a wound body, e.g. a circular cylindrical body. The alternating layers may be as hereinbefore described.

The body may be a wound body of a radial flow filter element as hereinbefore described.

The liquid may be forced radially from the outside to the inside through the wound body. Instead, the liquid may be forced radially from the inside to the outside through the wound body. This characteristic of the filter element is advantageous, as inadvertent incorrect connection of filter pipes would thus not necessarily damage the filter element.

The liquid may be forced through the body by means of a radial pressure differential across the body of at least about 0.2 bar but typically less than about 10 bar.

The method may include removing particles and water from the liquid, which may be an oil or a fuel.

According to a further aspect of the invention, there is provided a method of making a radial flow filter element, the method including co-winding a length of a liquid-permeable predominantly cellulosic material and a length of a liquid-permeable predominantly synthetic plastics or polymeric material around a core or mandrel to form a wound body.

The method may include first winding a length of liquid-permeable predominantly synthetic plastics or polymeric material around the core or mandrel to form a radially extending inner or filler zone of a desired thickness, and then continuing to co-wind the lengths of cellulosic material and synthetic plastics or polymeric material to form a radially extending filtration zone of a desired thickness.

The method may include discontinuing the winding of the length of cellulosic material once the filtration zone has reached its desired thickness, and continuing the winding of the length of synthetic plastics or polymeric material to form an outer zone of a desired thickness.

The method may include heat welding at least some of the wound layers of the outer zone together.

The method may include sealing ends of the wound body. The ends of the wound body may thus be provided with liquid-permeable end caps or seals, which may be as hereinbefore described.

The cellulosic material and the synthetic plastics or polymeric material may be as hereinbefore described.

The core is hollow and may consist predominantly of a cellulosic material, but with a much higher basis mass than the cellulosic material forming part of the wound body, e.g. cardboard. Instead, the core may be of a synthetic plastics or polymeric material, and may be of cage-like structure.

The invention extends to a filter element made in accordance with the method of the invention.

The invention will now be described, by way of example only, with reference to the accompanying diagrammatic drawings in which

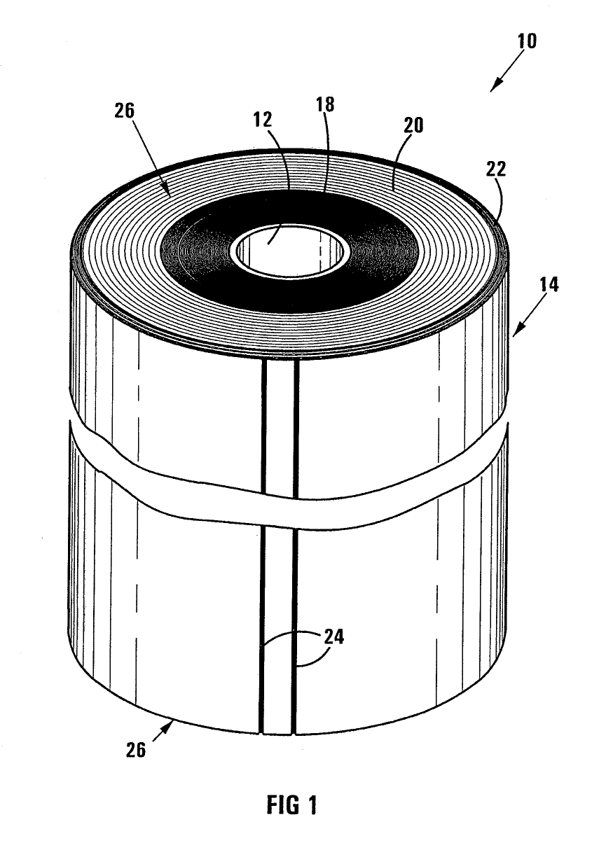

FIG. 1 shows a three-dimensional broken view of a filter element in accordance with the invention (without end caps);

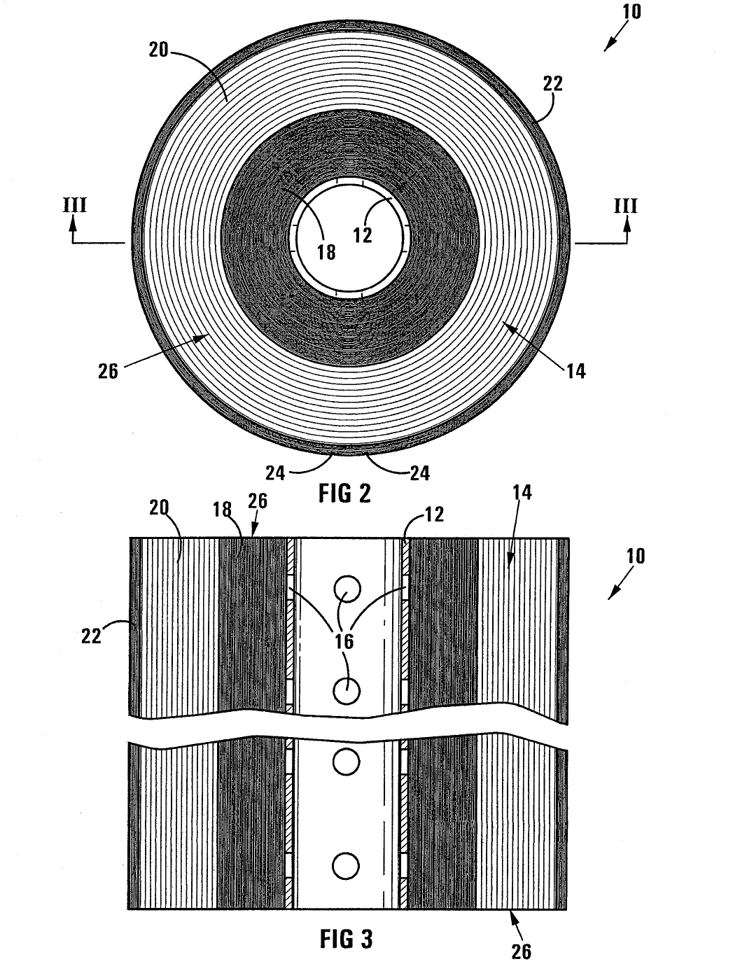

FIG. 2 shows a top plan view of the filter element of FIG. 1 (without end caps); and

FIG. 3 shows a vertical section through the filter element of FIG. 1, taken at III-III in FIG. 2 (without end caps).

Referring to the drawings, reference numeral 10 generally indicates a radial flow filter element in accordance with the invention, which is particularly suitable for filtering oil or fuel, e.g. diesel. The filter element 10 comprises a hollow open-ended liquid-pervious core or inner tube 12 and a circular cylindrical wound body 14 wound around the core 12.

The core 12 is circular cylindrical and is made from cardboard. The core 12 has a wall thickness of about 3 mm. A plurality of axially and circumferentially spaced apertures 16 is provided in the circular cylindrical wall of the core 12, rendering the core 12 liquid-pervious. In another embodiment of the invention (not shown) the core comprises a circular cylindrical body of a synthetic plastics or polymeric material, with rectangular openings arranged in rows and columns, providing the core with the appearance of a circular cylindrical cage or mesh.

The wound body 14 comprises three zones, namely a filler zone 18, a filtration zone 20 and an outer zone 22. The zones 18, 20, 22 extend axially so that the wound body 14 has the same length as the core 12, and also radially providing each zone with a radial dimension. Each zone 18, 20, 22 is thus annular in transverse cross-section or end view, as shown in FIG. 2. In one embodiment of the invention, the core 12 has an outer diameter of about 34 mm, the filler zone 18 has an outer diameter of about 50 mm, the filtration zone 20 has an outer diameter of about 93 mm and the outer zone 22 has an outer diameter of about 96 mm. In another embodiment of the invention, the core 12 has an outer diameter of about 34 mm, the filler zone 18 has an outer diameter of about 65 mm, the filtration zone 20 has an outer diameter of about 105 mm and the outer zone 22 has an outer diameter of about 110 mm.

The filler zone 18 consists of wound layers of a length of polyester material, with a basis mass of about 25 g/m².

The filtration zone 20 consists of alternating co-wound layers of the same length of polyester material and a length of a two-ply cellulosic material sold as “Wipes Jumbo Wiper Roll” (Item No. 91020) by Kimberly-Clark of South Africa (Proprietary) Limited. This cellulosic material has a basis mass for the combined plies of 33 g/m².

The outer zone 22 consists again only of wound layers of the same length of polyester material. At least some of the polyester layers of the outer zone 22 are heat-welded together leaving two longitudinally extending, circumferentially slightly spaced heat weld seams 24.

The filler zone 18 is thus sandwiched between the core 12 and the filtration zone 20 and the filtration zone 20 is in turn sandwiched between the filler zone 18 and the outer zone 22. In order to manufacture the filter element 10, a length of polyester material is first wound around the core 12 until the filler zone 18 has reached its desired diameter. Thereafter, the length of polyester material is further wound around the filler zone 18, together with a length of cellulosic material, until the filtration zone 20 has reached its desired diameter. Winding of the length of cellulosic material is then discontinued, e.g. by severing or cutting the length of cellulosic material but the length of polyester material is further wound around the filtration zone 20 until the outer zone 22 has reached its desired diameter. Thereafter, the length of polyester material is severed or cut and at least some of the polyester layers of the outer zone 22 are heat-welded together to prevent the wound body 14 from unwinding.

During the winding of the wound body 14, the length of polyester material and the length of cellulosic material are under a tension of between about 2.4 N and 11.8 N, preferably between about 2.9 N and about 8.8 N, more preferably between about 3.9 N and about 7.8 N, e.g. about 5.8 N.

Opposed annular end surfaces 26 of the wound body 14 are sealed with liquid-impermeable end caps (not shown), typically in the form of coatings of a liquid-impermeable material such as a rubberised coating, or a high temperature ABS plastics material glued onto the end surfaces 26.

In use, the filter element 10 is placed in a filter housing with a liquid inlet and a filtrate outlet arranged so that the liquid to be filtered is forced radially from the outside of the wound body 14 through the outer zone 22, the filtration zone 20 and the filler zone 18 into the hollow interior of the core 12, from where the filtrate is removed. The flow direction may however also be reversed with no loss in performance efficiency. In the filtration zone 20, particles down to a particle size of less than 0.2 μm are removed. Any water present in the liquid (typically oil or fuel) is also retained in the filtration zone 20. A differential pressure of between about 0.2 bar and about 10 bar across the wound body 14 can be used to force the liquid radially through the wound body 14. As a result of the presence of the filler zone 18 and the outer zone 22, which provide the wound body 14 with structural integrity, it is possible for the filter element 10 to withstand such high differential pressures.

The Applicant has found that a filter element similar to the filter element 10 of the invention but comprising only wound layers of a cellulosic material does not allow liquids such as fuel or oil to be filtered at sufficiently high flow rates and the Applicant has also found that such a filter blocks or blinds too quickly. Surprisingly, with the filter element 10, as illustrated, the Applicant has found that the filter flow rate can be increased by a factor up to 10. The reason for the surprisingly good performance of the filter element of the invention, as illustrated, is not clear to the Applicant. Without wishing to be bound by theory, the Applicant however suspects that the superb efficiency and filter capacity of the filter element 10 may have something to do with the interaction of the cellulosic fibres and synthetic plastics or polymeric fibres and the pores or interstices in the cellulosic material and synthetic plastics or polymeric material at the interfaces between the layers of cellulosic material and the layers of synthetic plastics or polymeric material. In particular, the Applicant suspects that the larger pores of the synthetic plastics or polymeric material, caused by the larger fibres of the synthetic plastics or polymeric material, shortens the path that liquid has to follow through the wound body 14, and also makes the path less torturous, compared to a wound body which consists only of layers of cellulosic material having smaller pores or interstices and smaller fibres. It is also possible that the larger fibres of the synthetic plastics or polymeric material do not as easily plug or obstruct pathways through the cellulosic material, as would be the case when only layers of cellulosic material are used. Surprisingly and advantageously, it appears thus possible to control the filter capacity (i.e. flow rate of liquid that can be filtered at a specified differential pressure) and the efficiency of the filter element, by varying the total interface or contact area in the filter element between the layers of synthetic plastics or polymeric material and the layers of cellulosic material.

1. A radial flow filter element which includes at least one wound body comprising a radially extending filtration zone with alternating co-wound liquid-permeable layers respectively of a predominantly cellulosic material and a predominantly synthetic plastics or polymeric material.

2. The filter element as claimed in claim 1, in which the layers of synthetic plastics or polymeric material have a higher liquid permeability than the layers of cellulosic material.

3. The filter element as claimed in claim 1, in which the layers of the cellulosic material and/or the synthetic plastics or polymeric material include more than one ply of respectively cellulosic material or synthetic plastics or polymeric material.

4. The filter element as claimed in claim 3, in which the layers of cellulosic material are formed from a length of cellulosic material of at least two plies, and the layers of synthetic plastics or polymeric material are formed from a length of synthetic plastics or polymeric material of single ply.

5. The filter element as claimed in claim 1, in which the cellulosic material and the synthetic plastics or polymeric material are compatible with oil and liquid hydrocarbon fuels, rendering the filter element an oil or fuel filter element.

6. The filter element as claimed in claim 1, in which the synthetic plastics or polymeric material is polyester with a basis mass of between about 10 g/m² and about 40 g/m².

7. The filter element as claimed in claim 1, in which the synthetic plastics or polymeric material is polypropylene.

8. The filter element as claimed in claim 1, which includes a radially spaced inner or filler zone which extends radially inwardly from the filtration zone and which is thus concentric with the filtration zone.

9. The filter element as claimed in claim 8, in which the inner or filler zone comprises liquid-permeable wound layers predominantly of a synthetic plastics or polymeric material, without any layers of a cellulosic material.

10. The filter element as claimed in claim 1, which includes a radially extending outer zone which comprises liquid-permeable wound layers predominantly of a synthetic plastics or polymeric material, without any layers of a cellulosic material.

11. The filter element as claimed in claim 1, in which ends of the wound body are provided with liquid-impermeable end caps.

12. A method of filtering a liquid, the method including forcing the liquid through a body comprising alternating liquid-permeable layers predominantly of a cellulosic material and predominantly of a synthetic plastics or polymeric material, the layers forming contact areas between them and the flow of liquid being normal to the contact areas.

13. The method as claimed in claim 12, in which the alternating layers are co-wound layers forming part of a wound body.

14. The method as claimed in claim 13, in which the body is a wound body of a radial flow filter element which includes at least one wound body comprising a radially extending filtration zone with alternating co-wound liquid-permeable layers respectively of a predominantly cellulosic material and a predominantly synthetic plastics or polymeric material.

15. A method of making a radial flow filter element, the method including co-winding a length of a liquid-permeable predominantly cellulosic material and a length of a liquid-permeable predominantly synthetic plastics or polymeric material around a core or mandrel to form a wound body.

16. The method as claimed in claim 15, which includes first winding a length of liquid-permeable predominantly synthetic plastics or polymeric material around the core or mandrel to form a radially extending inner or filler zone of a desired thickness, and then continuing to co-wind the lengths of cellulosic material and synthetic plastics or polymeric material to form a radially extending filtration zone of a desired thickness.

17. The method as claimed in claim 16, which includes discontinuing the winding of the length of cellulosic material once the filtration zone has reached its desired thickness, and continuing the winding of the length of synthetic plastics or polymeric material to form an outer zone of a desired thickness.

18. The method as claimed in claim 17, which includes heat welding at least some of the wound layers of the outer zone together and sealing ends of the wound body.

19. The method as claimed in claim 15, in which the core is hollow and consists predominantly of a cellulosic material, but with a much higher basis mass than the cellulosic material forming part of the wound body.

20. The method as claimed in claim 15, in which the core is hollow and is of a synthetic plastics or polymeric material.
